(19) United States
(12) Patent Application Publication
(10) Pub. No.: US 2014/0340885 A1
(43) Pub. Date: Nov. 20, 2014

(54) Linear LED Display Case Light

(71) Applicants: Robert Lockwood, Black Diamond, WA (US); Kenneth Lockwood, Anaheim, CA (US)

(72) Inventors: Robert Lockwood, Black Diamond, WA (US); Kenneth Lockwood, Anaheim, CA (US)

(21) Appl. No.: 14/279,985

(22) Filed: May 16, 2014

Related U.S. Application Data
(60) Provisional application No. 61/825,346, filed on May 20, 2013.

(51) Int. Cl. F21S 4/00; F21V 21/00

(52) U.S. Cl. CPC F21S 4/003; F21V 21/00
USPC 362/223

(57) ABSTRACT

A linear LED display case light provides an adjustable swath of light. The swath of light emanates from a linear LED array residing in a generally round or polygonal cross-section housing. The housing has two polarity sensitive ends and is slidably coupled by sliding drums to two electrically conducting vertical rods located at each end of the housing, by adjustable couplings. The drums include locks for holding a vertical position on the rods. Machine screws having a smooth cylindrical belt under screw heads, pass through springed contacts, providing a horizontal axis of rotation for the housing to adjust the swath of light forward and rearward. The springed contacts electrically connect the vertical rods to the linear LED array. The vertical rods are secured to a solid surface and are electrically connectable to a power source.

### CROSS-REFERENCE TO RELATED APPLICATIONS

The present application claims the priority of U.S. Provisional Patent Application Ser. No. 61/825,346 filed May 20, 2013, which application is incorporated in its entirety herein by reference.

### BACKGROUND OF THE INVENTION

The present invention relates to lighting and in particular to display case lighting.

Items are often displayed for showing and for sale. Such items often have details or designs of interest to viewers, and which require lighting to clearly view. When display cases include glass or clear plastic windows to protect the items, light from outside the display may cause glare and reflections. Linear display case lights are known, but are not easily assembled or adjusted, and a need remains for a simple linear display case light.

### BRIEF SUMMARY OF THE INVENTION

The present invention addresses the above and other needs by providing a linear LED display case light which provides an adjustable swath of light. The swath of light emanates from a linear LED array residing in a generally round or polygonal cross-section housing. The housing has two polarity sensitive ends and is slidably coupled by sliding bocks to two electrically conducting vertical rods located at each end of the housing, by adjustable couplings. The blocks include locks for holding a vertical position on the rods. Machine screws having a smooth cylindrical belt under screw heads, pass through springed contacts, providing a horizontal axis of rotation for the housing to adjust the swath of light forward and rearward. The springed contacts electrically connect the vertical rods to the linear LED array. The vertical rods are secured to a solid surface and are electrically connectable to a power source.

In accordance with one aspect of the invention, there are provided pivots at each end of the LED housing providing a firm, but smooth, rotation. The pivots comprise insulators, machine screws and springed contacts. The machine screws have a smooth cylindrical belt under screw heads, passing through the springed contact, providing a horizontal axis of rotation allowing the housing to rotate about the axis to adjust the swath of light forward and rearward and providing friction to hold a position of the housing. The insulators electrically insulate the LED housing from the machine screws and springed contacts.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a perspective view of a linear LED display case light according to the present invention.

FIG. 2 is an exploded view of the linear LED display case light according to the present invention.

FIG. 3 is a perspective view of a coupling according to the present invention, of the linear LED display case light.

FIG. 4 is a side view of the coupling according to the present invention, of the linear LED display case light.

FIG. 5 is a machine screw of the coupling according to the present invention, of the linear LED display case light.

FIG. 6A is a side view of an springed connector of the coupling according to the present invention.

FIG. 6B is a rear view of the springed connector of the coupling according to the present invention.

FIG. 6C is a rear perspective view of the springed connector of the coupling according to the present invention.

FIG. 6D is a front perspective view of the springed connector of the coupling according to the present invention.

FIG. 7 shows mounting hardware for the linear LED display case light according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

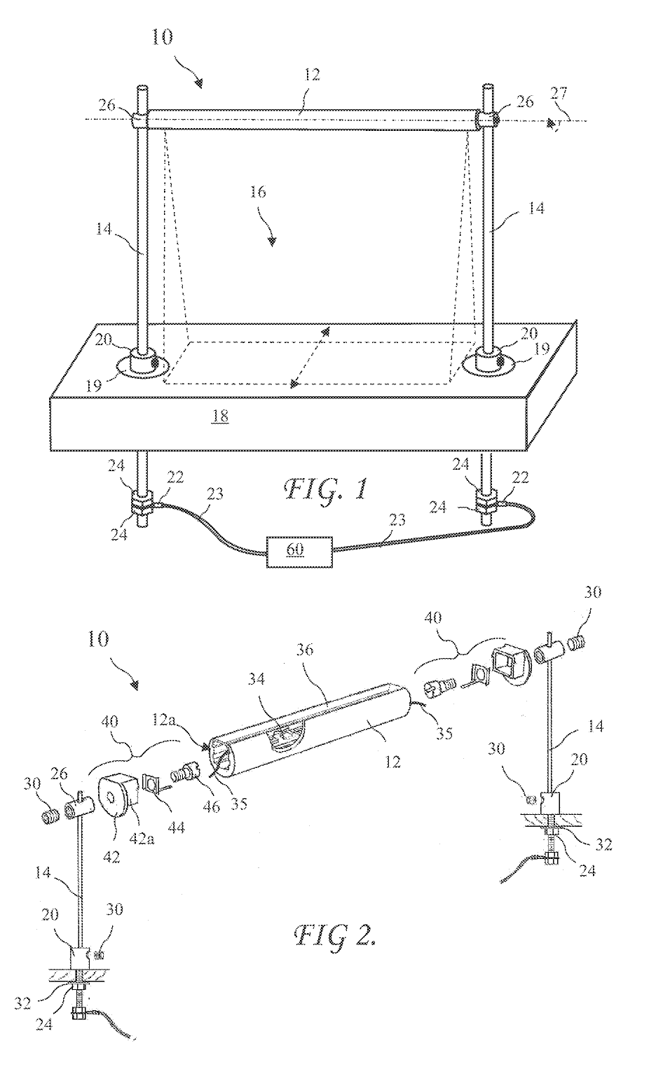

A perspective view of a linear LED display case light 10 according to the present invention is shown in FIG. 1, and an exploded view of the linear LED display case light 10 is shown in FIG. 2. The linear LED display case light 10 is supported by, and electrically coupled to, two vertical rods 14 by drums 26. The rods 14 may be mounted to a fixed or stationary support 18 using bases 20 and nuts 24. The rods 14 electrically connect a linear LED array 34 residing in a housing 12 to electrical connections 22 connected to a low voltage power source 60 by wire leads 23. The rods 14 may be connected to the electrical connections 22 using additional nuts 24. While the connection of the rods 14 to the electrical connections 22 is shown to be below the support 18, the connection may be above the support 18, or in the support 18.

When the support 18 is a non-conducting material, the rods 14 may directly contact the support 18. When the support 18 is an electrically conducting material, the rods 14 are insulated from the support 18 by at least one insulator 19. A window 36 in the housing 12 allows light to escape the housing 12. The linear LED display case light 10 operates on low voltage power, for example 12 Volts Direct Current (VDC) and there is not danger of electrical shock from contact to the rods 14.

The drums 26 are vertically slidable on the rods 14 and include locks to hold the drums 26 position on the rods 24. An example of a lock is a set screw 30 threadably engaging drums 26. The housing 12 is rotatable around an axis 27 to move a swath of light 16 produced by the linear LED array 34 forward and rearward. Such rotation may be provided, for example, by screws 46 holding insulators 42 to the drums 26. The screws 46 further electrically connect springed contacts 44 to the rods 14, and the springed contacts 44 further electrically connect to the linear LED array 34 through wire leads 35. The drums 26 may be cylindrical, or be any form of block providing a surface allowing the insulators 42 to rotate.

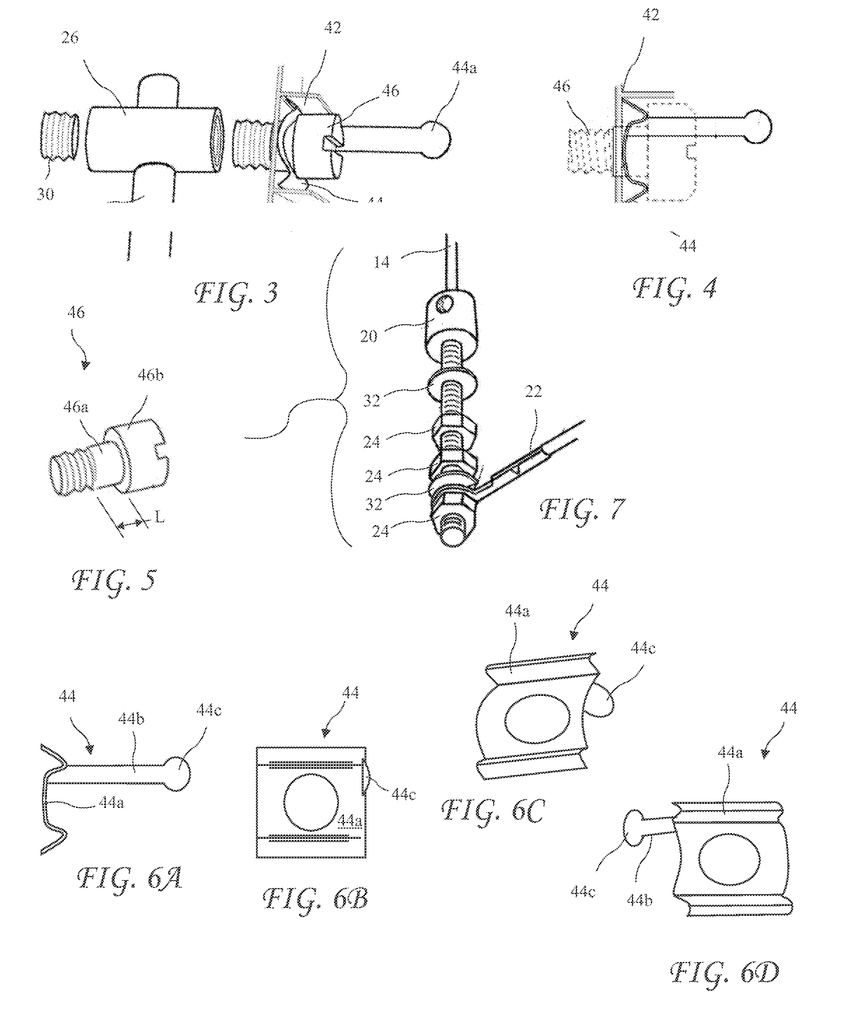

A perspective view of the coupling 40 is shown in FIG. 3, a side view of the coupling 40 is shown in FIG. 4, the screw 46 of the coupling 40 is shown in FIG. 5, and side, rear, rear perspective, and front perspective views of the springed connector 44 are shown in FIGS. 6A-6D. The screw 46 passes through the springed connector 44 and the insulator 42 and engages the drum 26. The insulators 42 are pressed into opposite ends of the housing 12, preferably having an interference fit to the housing 12 but may snap in, be glued in, or attached by other means, and more preferably the isolators 42 have a non-round male portion 42a inserting into a matching female mouth 12a of the housing 12. The springed connectors 44 include solder pads 44a at ends of arms 44b, and the linear LED array 34 wire leads 35 (see FIG. 2) may be soldered to the solder pads 44a before assembly. The screw 46 includes a smooth cylindrical belt 46a under the head 46b providing smooth sliding contact with the springed contact 44 to somewhat flatten the curved center portion 44a to provide resistance to rotation of the springed contact 44 with respect to the drum 26, allowing the housing 12 to rotate freely and to hold a position. The smooth cylindrical belt 46a has a length L of approximately 0.115 inches, the smooth cylindrical belt 46a limiting the engagement of the machine screw 46 into the drum 26.

The mounting hardware 50 of the linear LED display case light 10 is shown in FIG. 7. The mounting hardware 50 includes the bases 20, washers 32, and nuts 24. The support 18 (see FIG. 1) is sandwiched between the bases 20 and washers 32, using the nuts 24.

While the invention herein disclosed has been described by means of specific embodiments and applications thereof, numerous modifications and variations could be made thereto by those skilled in the art without departing from the scope of the invention set forth in the claims.

1. A linear LED display case light comprising:
a base (18);
two laterally spaced parts electrically conducting vertical rods (14) attached to the base;
blocks (26) electrically connected to the vertical rods and sliding vertically on each vertical rod and lockable to a position on the respective vertical rod;
couplings (40) pivotally attached to each block;
a housing (12) attached between the couplings and electrically insulated from the blocks by the couplings;
a linear LED array (34) residing in the housing and electrically connected to the blocks through the couplings;
a window (36) through the housing and aligned with light emitted by the LEDs; and
a low voltage power source (50) electrically connected to the two vertical rods.

2. The display case light of claim 1, wherein the couplings comprise:
a springed contact (44) including a curved center portion (44a) and a solder pad (44c);
a machine screw (46) passing though the curved center portion and threadably engaging the block (26); and
an insulator (42) held by each coupling and electrically insulating the housing from the blocks.

3. The display case light of claim 2, wherein lead wires (35) electrically connecting the solder pads to the linear LED array.

4. The display case light of claim 3, wherein the isolators include a male portion engaging female mouths in ends of the housing to hold the housing.

5. The display case light of claim 4, wherein the springed contacts are held inside the female mouths in ends of the housing without contacting the housing.

6. The display case light of claim 5, wherein the springed contacts include arms reaching into the housings, the solder pads on ends of the arms opposite to the curved center portions, the arms and solder pads held inside the female mouths in the ends of the housing without contacting the housing.

7. The display case light of claim 2, wherein the machine screws include a smooth cylindrical belt (46a) under a head of the machine screw, the smooth cylindrical belt passing through the curved center portion of the springed contact to somewhat flatten the curved center portion to provide resistance to rotation of the springed contact with respect to the block and to hold a position of the springed contact with respect to the block.

8. The display case light of claim 7, wherein the machine screws hold the isolators between the springed contacts and the blocks.

9. The display case light of claim 8, wherein the smooth cylindrical belt have a length L of approximately 0.115 inches.

10. The display case light of claim 9, wherein the smooth cylindrical belt limits the engagement of the machine screw into the drum

11. The display case light of claim 1, wherein the locks are set screws.

12. A linear LED display case light comprising:
a base (18);
two laterally spaced parts electrically conducting vertical rods (14) attached to the base;
drums (26) having a horizontal threaded passage coaxial with a drum centerline and a smooth vertical passage orthogonal to the threaded passage, the smooth passage sliding vertically on each corresponding vertical rod;
couplings (40) pivotally attached to each of the drums, each coupling comprising:
a springed contact (44) including a curved center portion (44a) and a solder pad (44c) on an arm (44b) reaching away from the curved center portion;
a machine screw (46) passing though the curved center portion and threadably engaging the horizontal threaded passage of the drum (26), the machine screw including a smooth cylindrical belt (46a) having a length L of approximately 0.115 inches under a head of the machine screw, the smooth cylindrical belt passing through the curved center portion of the springed contact to somewhat flatten the curved center portion to provide resistance to rotation of the springed contact with respect to the drum and to hold a position of the springed contact with respect to the drum, the smooth cylindrical belt limiting the engagement of the machine screw into the drum; and
an insulator (42) held by the machine screw between the springed contact and the drum;
set screws (30) holding the drums at vertical locations on the rods;
a housing (12) residing between the couplings, the housing held by the
a linear LED array (34) residing in the housing and electrically connected to the solder pads by wire leads 35;
a window (36) through the housing and aligned with light emitted by the LEDs; and
a low voltage power source (60) electrically connected to the two vertical rods.
